(19) United States
(12) Patent Application Publication
(10) Pub. No.: US 2024/0270950 A1
(43) Pub. Date: Aug. 15, 2024

(54) POLYISOBUTENE WITH HIGH CONTENT OF CERTAIN DOUBLE BOND ISOMERS

(71) Applicant: BASF SE, Ludwigshafen Am Rhein (DE)

(72) Inventors: Paul Lederhose, Ludwigshafen (DE); Bernard Pierre, Antwerpen (BE); Thomas Wettling, Ludwigshafen (DE); Markus Brym, Ludwigshafen (DE)

(73) Assignee: BASF SE, Ludwigshafen Am Rhein (DE)

(21) Appl. No.: 18/566,587

(22) PCT Filed: May 30, 2022
(86) PCT No.: PCT/EP2022/064598

§ 371 Date: Dec. 1, 2023

(30) Foreign Application Priority Data
Jun. 7, 2021 (EP) 21177948.3

(51) Int. Cl. C08L 23/22; C08F 8/48

(52) U.S. Cl. CPC C08L 23/22; C08F 8/48; C08L 2205/025

(57) ABSTRACT

Polyisobutene mixtures are made with an increased content of polyisobutene isomers with a beta-double bond.

The present invention concerns polyisobutene mixtures with an increased content of polyisobutene isomers with a beta-double bond.

In the past efforts were made to prepare polyisobutene with a high reactivity for subsequent chemical reactions, e.g. subsequent hydroformylation, thermal ene-reaction with maleic anhydride, or Friedel-Crafts alkylation of aromatic compounds. As a result, highly reactive polyisobutene (also referred to as HRPIB) was developed with a high content of alpha-double bonds up to 80 to 90 mol % (see below for the designation of the isomers) or even higher contents up 95, 97 or even 98%.

WO 02/079283 A1 discloses polyisobutene polymer compositions comprising polyisobutene molecules with an alpha-double bond (less than 70%) and molecules with a beta-double bond (alpha and beta (in sum) at least 90%) as well as no more than 10% molecules with a tetra-substituted internal double bond. Such compositions are obtained by a certain liquid phase polymerization process.

However, WO 02/079283 A1 is silent about other isomers than those three mentioned above and furthermore does not disclose a process how one isomer is converted into another.

Typical compositions of conventional and highly reactive polyisobutene mixtures are compared in WO 2019/108723 A1: The content of high reactive alpha-double bonds is 50 to 90 mol % in HRPIB but only 4 to 5 mol % in conventional polyisobutene, while the content of isomers with a vinylidene beta-double bond is 6 to 35 mol % in HRPIB, but nearly non-existing (0 to 2 mol %) in conventional polyisobutene.

However, in the unpublished European Patent Application No. 20208053.7, filed 17. November 2020, a process for a photo oxygenation of polyisobutene was disclosed, in which the reactivity of the double bonds in polyisobutene towards singlet oxygen increases from alpha-double bonds to beta-double bonds and finally to tetra-substituted double bonds.

Therefore, a need exists for polyisobutene compositions with an increased content of isomers with vinylidene beta-double bonds. Vinylidene beta-double bonds are sufficiently reactive both in a photo oxygenation as well in a thermal reactions, while alpha-double bonds are highly reactive in thermal reactions, but of only little reactivity in photo oxygenation, while tetra-substituted double bonds are highly reactive in photo oxygenation but exhibit only little reactivity in thermal reactions.

In Macromolecules, 2011, 44(7), pages 1831-1840, “Mechanism of Isomerization in the Cationic Polymerization”, R. Faust et al. disclose DFT calculations regarding the relative stability of different polyisobutene isomers.

While the tetra-substituted isomer (C4) is lowest in energy, another tetra-substituted isomer (C3) has an energy content of just 2.63 kJ/mol higher. In contrast the isomer (A) with an alpha-double bond is 30.46 kJ/mol higher and the isomer (B) which is desired according to the present invention is even 33.98 kJ/mol higher (for the designation of the isomers see below).

Hence, among these four isomers the desired isomer (B) is highest in energy and, therefore, under thermodynamic control of the reaction conditions expected to be formed least in equilibrium.

The problem was solved by polyisobutene-containing compositions, comprising
20 to less than 65 mol %, preferably 25 to 50, more preferably 30 to 40 mol % polyisobutene species (A) bearing an alpha-double bond,
more than 35 to 80 mol %, preferably 40 to 70, more preferably 45 to 65 and most preferably 50 to 60 mol % polyisobutene species (B) bearing a vinylidene beta-double bond,
up to 20 mol % (in sum) polyisobutene isomers (C) other than (A) and (B),
   selected from the group consisting of

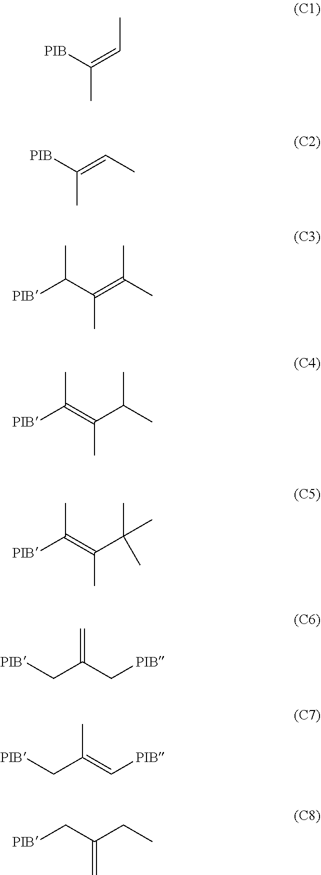

in which PIB′ and PIB″ refer to appropriately shortened polymeric backbones of the polyisobutene,
wherein at least one of the isomers (C1), (C2), (C6), (C7), and (C8) is present,
preferably from 1 to 19 mol %, more preferably from 2 to 18 mol %, most preferably from 3 to 17 mol %, and especially from 5 to 15 mol %,
   optionally up to 4 mol % (in sum) furthermore halogenated polyisobutenes (D1) and/or fully saturated polyisobutenes (D2),
wherein the sum of (A), (B), (C), and (D) always adds up to 100 mol % and
the Mn of the polyisobutene composition is from 500 to 10000.

The polymeric backbones PIB′ and PIB″ together with the explicitly shown atom groups in the structures (C3) to (C8) form the polyisobutene with an Mn of from 500 to 10000. Such a polymeric backbone consists of reactive monomers in polymerised form present in the isobutenic C₄ hydrocarbon stream used in the polymerisation (see below), preferably predominantly comprises isobutene in polymerised form, more preferably consists of isobutene in polymerised form. Additionally, one of the polymeric backbones PIB′ and PIB″ comprises the residue of the initiator used, or a group derived thereof (see below). In a polyisobutene with a number average molecular weight Mn from 500 to 10000 the polymer in total comprises approx. from 8 to 180 monomer units, with an Mn from 750 to 3000 from 13 to 54 monomer units, with an Mn from 900 to 2500 from 16 to 45 monomer units, and with an Mn from 900 to 1100 from 16 to 20 monomer units, which corresponds to the degree of polymerisation.

Another subject matter of the present invention is a process for preparation of such compositions, comprising the steps of
choosing as a starting material a polyisobutene composition with a content of polyisobutene species (A) bearing an alpha-double bond of at least 70 mol %, preferably at least 75 mol %, more preferably at least 80 mol %, most preferably at least 85 mol % and especially at least 90 mol %,
optionally at least one solvent,
treating the optionally dissolved polyisobutene composition
   in the presence of at least one acidic solid state catalyst, optionally treated with at least one Brønsted-base
   for a period of from 10 minutes to 36 hours
   at a temperature of from 40° C. to 250° C.

Another subject matter of the present invention is the use of such compositions in reactions to obtain further derivatives, preferably in oxidation reactions, more preferably in photo oxygenations.

In the context of the present invention the term isomers bearing a “vinylidene beta-double bond” refers to polyisobutene isomers (B) with the sub-structure

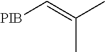

in which
“PIB” stands for the polymeric backbone of the polyisobutene except for the final incorporated isobutene unit. Such a polymeric backbone consists of reactive monomers in polymerised form present in the isobutenic C₄ hydrocarbon stream used in the polymerisation (see below), preferably predominantly comprises isobutene in polymerised form, more preferably consists of isobutene in polymerised form. Additionally, the polymeric backbone comprises the residue of the initiator used, or a group derived thereof (see below). In a polyisobutene with a number average molecular weight Mn from 500 to 10000 the polymer in total comprises approx. from 8 to 180 monomer units, with an Mn from 750 to 3000 from 13 to 54 monomer units, with an Mn from 900 to 2500 from 16 to 45 monomer units, and with an Mn from 900 to 1100 from 16 to 20 monomer units, which corresponds to the degree of polymerisation.

In contrast, the term isomers bearing an “alpha-double bond” refers to polyisobutene isomers (A) with the sub-structure

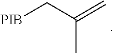

Other polyisobutene isomers (C) may be

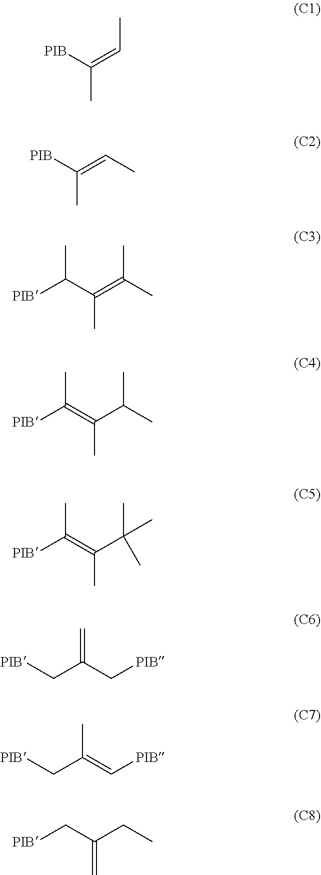

in which PIB′ and PIB″ refer to appropriately shortened polymeric backbones of the polyisobutene. Such a shortened polymeric backbone, especially PIB″, comprises at least one isobutene unit in polymerised form.

Further to components (A), (B), and (C) the mixture may comprise other polyisobutene-derived species (D):

Furthermore, halogenated polyisobutenes (D1) may be found.

Furthermore, fully saturated polyisobutenes (D2) may be found, which do not comprise any multiple bonds at all and are not halogenated.

Although isomers (C1) and (C2) also represent trisubstituted polyisobutene isomers with a beta-double bond they are distinguished from compound (B) since their reactivity in a photo oxygenation is different from compound (B): While compound (B) comprises six (nearly) equivalent hydrogen atoms on the two methyl groups in allylic position to the double bond which yield the same product on photo oxygenation, isomers (C1) and (C2) each comprise two different methyl groups which lead to different photo oxygenation products. Therefore, use of compound (B) in a photo oxygenation yields a more uniform reaction mixture, thus, compound (B) is preferred over compounds (C1) and (C2). It furthermore is assumed that compound (B) under reaction conditions of photo oxygenation appears to be less sterically hindered than isomers (C1) and (C2) which is a further advantage of polyisobutene compositions with a higher content of compound (B).

Isomers (C3), (C4), and (C5) together with their (E)- and (Z)-isomers (not shown) represent tetrasubstituted isomers. Although the tetrasubstituted isomers are highly reactive in photo oxygenation they are unwanted since they lead to complex reaction mixtures due to their number of different reaction sites in photo oxygenation.

However, it is an advantage of tetrasubstituted double bonds that they are less reactive in thermal reactions, therefore, the presence of isomers (C3), (C4), and (C5) is preferred when high-temperature reactions are performed with polyisobutene comprising such isomers, especially with polyisobutene comprising tetra-substituted end groups (C3).

Isomers (C6) and (C7) are isomers with an internal double bond, since the double bond is at least one isobutene unit in polymerised form apart from the end of the polymer backbone, although isomer (C7) is less reactive than (C6) due to its double bond in the polymer backbone. This, again, emphasises the role of an accessible double bond in polyisobutenes.

Isomers (C6) are advantageous since they are known to yield fuel and lubricant additive derivatives with better performance properties, as disclosed in U.S. Pat. No. 9,688,791 B2.

While isomer (C6) is advantageous for a higher reactivity especially in thermal reactions, isomer (C7) exhibits an advantage in photo reactions, especially photo oxygenations.

Isomer (C8) is the product of a methyl group rearrangement.

In a preferred embodiment isomer (C1) is present in the compositions according to the present invention.

In another preferred embodiment isomer (C2) is present in the compositions according to the present invention.

In another preferred embodiment isomer (C6) is present in the compositions according to the present invention.

In another preferred embodiment isomer (C7) is present in the compositions according to the present invention.

In another preferred embodiment isomer (C8) is present in the compositions according to the present invention.

Such isomers independently of another are present in the compositions according to the present invention in amounts of at least 0.5 mol %, preferably at least 1 mol %.

### Composition

The amount of polyisobutene species (A) bearing an alpha-double bond in the polyisobutene-containing composition according to the invention is from 20 to less than 65 mol %, preferably from 25 to 50, more preferably 30 to 45 mol %, and especially from 35 to 40 mol %.

The amount of polyisobutene species (B) bearing a vinylidene beta-double bond in the polyisobutene-containing composition according to the invention is from more than 35 to 80 mol %, preferably 40 to 70, more preferably 45 to 65, and especially 50 to 60 mol %,

The amount of optional polyisobutene isomers (C) other than (A) and (B) in the polyisobutene-containing composition according to the invention is optionally up to 20 mol % (in sum), preferably from 1 to 19 mol %, more preferably from 2 to 18 mol %, most preferably from 3 to 17 mol %, and especially from 5 to 15 mol %.

The polyisobutene-containing composition according to the invention may furthermore optionally contain halogenated polyisobutenes (D1) in amounts of not more than 2 mol %, preferably not more than 1.5 mol %, more preferably not more than 1 mol %, and especially not more than 0.5 mol %. Halogen contents of not more than 0.3 mol %, not more than 0.2 mol %, and even 0.1 mol % are even more preferred.

The polyisobutene-containing composition according to the invention may furthermore optionally contain fully saturated polyisobutenes (D2) in amounts of not more than 15 mol %, preferably not more than 10 mol %, more preferably not more than 5 mol %, and especially not more than 2 mol %.

The sum of all isomers (A), (B), and (C) as well as potential other components (D) selected from the group consisting of halogenated polyisobutenes (D1) and fully saturated polyisobutene (D2) always add up to 100 mol %.

The amounts of isomers given throughout the text refer to mol %, unless explicitly stated otherwise. Since the determination of the individual or groups of isomers is conducted by NMR analysis (details see below) the result of such NMR analysis is a percental distribution of certain NMR signals of these isomers relative to the integral of the respective nucleus determined.

The number-average molecular weight Mn (determined by gel permeation chromatography) of the polyisobutene composition is from 500 to 10000, preferably from 550 to 5000, more preferably from 750 to 3000, most preferably from 900 to 2500, and especially from 900 to 1100.

In a preferred embodiment the compositions according to the invention are prepared from polyisobutene compositions with a higher content of alpha-double bonds of at least 70 mol %, preferably at least 75 mol %, more preferably at least 80 mol %, most preferably at least 85 mol % and especially at least 90 mol %.

Therefore, an object of the present invention is a process for preparation of compositions according to the present invention, comprising the steps of
choosing as a starting material a polyisobutene composition with a content of polyisobutene species (A) bearing an alpha-double bond of at least 70 mol %,
optionally at least one solvent,
treating the optionally dissolved polyisobutene composition
   in the presence of at least one acidic solid state catalyst, optionally treated with at least one Brønsted-base
   for a period of from 10 minutes to 36 hours
   at a temperature of from 40° C. to 250° C.

Processes for the preparation of such polyisobutene compositions with a higher content of alpha-double bonds are known in the prior art and are relevant for the present invention insofar that they are required for the preparation of the starting material of the process according to the present invention.

For the preparation of such polyisobutene compositions with a higher content of alpha-double bonds usually isobutene or an isobutenic starting material is polymerised in the presence of at least one Lewis Acid-donor complex and an initiator.

As a Lewis Acid usually metal halides are used, preferably halides of boron, aluminium, iron, gallium, titanium, zinc or tin.

Typical examples are boron trifluoride, boron trichloride, aluminum trihalide, alkylaluminum dihalide, dialkylaluminum halide, iron trihalide, gallium trihalide, titanium tetrahalide, zinc dihalide, tin dihalide, tin tetrahalide, wherein the halide is preferably fluoride or chloride, more preferably chloride.

Preferred are boron trifluoride, aluminum trichloride, alkyl aluminum dichloride, dialkyl aluminum chloride, and iron trichloride, more preferred are boron trifluoride, aluminum trichloride, and alkyl aluminum dichloride, most preferred are boron trifluoride and aluminum trichloride with boron trifluoride being especially preferred.

Examples for suitable donor compounds comprise at least one oxygen and/or nitrogen atom with at least one lone electron pair, preferably at least one oxygen atom with at least one lone electron pair and very preferably are selected from the group consisting of organic compounds with at least one ether function, organic compounds with at least one carboxylic ester function, organic compounds with at least one aldehyde function, organic compounds with at least one keto function, and organic compounds with at least one nitrogen containing heterocyclic ring.

Solely oxygen containing donor compounds are preferred over nitrogen-containing donor compounds.

Preferably the donor is selected from the group consisting of organic compounds with at least one ether function, organic compounds with at least one carboxylic ester function and organic compounds with at least one keto function, more preferably selected from the group consisting of organic compounds with at least one ether function and organic compounds with at least one carboxylic ester function, very preferably donors are organic compounds with at least one ether function, and especially organic compounds with exactly one ether function.

Compounds with at least one ether function are also understood to mean acetals and hemiacetals. The ether compound may comprise one or more ether functions, e.g. one, two, three, four or even more ether functions, preferably one or two ether functions and very preferably one ether function.

The mixture of donors may comprise one, two, three, four or even more different compounds, preferably compounds with at least one ether function, preferably one or two different compounds and very preferably one compound.

It may be an advantage to use a mixture of two different donors, especially two different ethers, see e.g. WO 2017/1140603 for aluminium halide-donor complexes

In a preferred embodiment of the present invention, a boron trihalide-donor complex, an aluminum trihalide-donor complex or an alkylaluminum halide complex, or an iron trihalidedonor complex, or a gallium trihalide-donor complex or a titanium tetrahalide-donor complex or a zinc dihalide-donor complex or a tin dihalide-donor complex or the tin tetrahalide-donor complex or the boron trihalide-donor complex, very preferably a boron trihalide-donor complex, an aluminum trihalide-donor complex or an iron trihalide-donor complex or a boron trihalide-donor complex and especially a boron trihalide-donor complex or an aluminum trihalide-donor complex is used, which comprises, as the donor, at least one dihydrocarbyl ether the general formula R⁸—O—R⁹ in which the variables R⁸ and R⁹ are each independently C₁- to C₂₀-alkyl radicals, preferably C₁- to C₈ alkyl radicals especially C₁- to C₄ alkyl radicals, C₁- to C₂₀-haloalkyl radicals, preferably C₁- to C₈ haloalkyl radicals especially C₁- to C₄ haloalkyl radicals, C₅- to C₈-cycloalkyl radicals, preferably C₅- to C₆-cycloalkyl radicals, C₆- to C₂₀-aryl radicals, especially C₆- to C₁₂ aryl radicals, C₆- to C₂₀-haloaryl radicals, especially C₆- to C₁₂ haloaryl radicals, or C₇- to C₂₀-arylalkyl radicals, especially C₇- to C₁₂-arylalkyl radicals. Preference is given to C₁- to C₄ alkyl radicals, C₁- to C₄ haloalkyl radicals, C₆- to C₁₂ aryl radicals, and C₇- to C₁₂-arylalkyl radicals

Haloalkyl and haloaryl mean preferably chloroalkyl or bromoalkyl and chloroaryl or bromoaryl, very preferably chloroalkyl and chloroaryl. Especially preferred are w-haloalkyl radicals.

Preferred examples are chloromethyl, 1-chloroeth-1-yl, 2-chloroeth-1-yl, 2-chloroprop-1-yl, 2-chloroprop-2-yl, 3-chloroprop-1-yl, and 4-chlorobut-1-yl.

Preferred examples for chloroaryl are 2-chlorophenyl, 3-chlorophenyl, and 4-chlorophenyl.

The dihydrocarbyl ethers mentioned may be open-chain or cyclic, where the two variables R⁸ and R⁹ in the case of the cyclic ethers may join to form a ring, where such rings may also comprise two or three ether oxygen atoms. Examples of such open-chain and cyclic dihydrocarbyl ethers are dimethyl ether, chloromethyl methyl ether, bis (chloromethyl) ether, diethyl ether, chloromethyl ethyl ether, 2-chloroethyl ethyl ether (CEE), bis (2-chloroethyl) ether (CE), di-n-propyl ether, diisopropyl ether, di-n-butyl ether, di-sec-butyl ether, diisobutyl ether, di-n-pentyl ether, di-n-hexyl ether, di-n-heptyl ether, di-n-octyl ether, di-(2-ethylhexyl) ether, methyl n-butyl ether, methyl sec-butyl ether, methyl isobutyl ether, methyl tert-butyl ether, ethyl n-butyl ether, ethyl sec-butyl ether, ethyl isobutyl ether, ethyl tert-butyl ether, n-propyl-n-butyl ether, n-propyl sec-butyl ether, n-propyl isobutyl ether, n-propyl tert-butyl ether, isopropyl n-butyl ether, isopropyl sec-butyl ether, isopropyl isobutyl ether, isopropyl tert-butyl ether, methyl n-hexyl ether, methyl n-octyl ether, methyl 2-ethylhexyl ether, ethyl n-hexyl ether, ethyl n-octyl ether, ethyl 2-ethylhexyl ether, n-butyl n-octyl ether, n-butyl 2-ethylhexyl ether, tetrahydrofuran, tetrahydropyran, 1,2-, 1,3- and 1,4-dioxane, dicyclohexyl ether, diphenyl ether, alkyl aryl ethers, such as anisole and phenetole, ditolyl ether, dixylyl ether and dibenzyl ether.

Furthermore, difunctional ethers such as dialkoxybenzenes, preferably dimethoxybenzenes, very preferably veratrol, and ethylene glycol dialkylethers, preferably ethylene glycol dimethylether and ethylene glycol diethylether, are preferred.

Among the dihydrocarbyl ethers mentioned, diethyl ether, 2-chloroethyl ethyl ether, diisopropyl ether, di-n-butyl ether and diphenyl ether have been found to be particularly advantageous as donors for the boron trihalide-donor complexes, the aluminum trihalide-donor complexes or the alkylaluminum halide complexes or the iron trihalide-donor complexes or the gallium trihalide-donor complex or the titanium tetrahalide-donor complex or the zinc dihalide-donor complex or the tin dihalide-donor complex or the tin tetrahalide-donor complex or the boron trihalide-donor complex, very preferably boron trihalide-donor complexes, the aluminum trihalide-donor complexes or iron trihalide-donor complexes or boron trihalide-donor complex and especially the a boron trihalide-donor complexes or the aluminum trihalidedonor complexes.

In a preferred embodiment dihydrocarbyl ethers with at least one secondary or tertiary dihydrocarbyl group are preferred over dihydrocarbyl groups with primary groups only. Ethers with primary dihydrocarbyl groups are those ethers in which both dihydrocarbyl groups are bound to the ether functional group with a primary carbon atom, whereas ethers with at least one secondary or tertiary dihydrocarbyl group are those ethers in which at least one dihydrocarbyl group is bound to the ether functional group with a secondary or tertiary carbon atom.

For the sake of clarity, e.g. diisobutyl ether is deemed to be an ether with primary dihydrocarbyl groups, since the secondary carbon atom of the isobutyl group is not bound to the oxygen of the functional ether group but the hydrocarbyl group is bound via a primary carbon atom.

Preferred examples for ethers with primary dihydrocarbyl groups are diethyl ether, di-n-butyl ether, and di-n-propyl ether.

Preferred examples for ethers with at least one secondary or tertiary dihydrocarbyl group are diisopropyl ether, methyl tert-butyl ether, ethyl tert-butyl ether, and anisole.

In addition, particularly advantageous dihydrocarbyl ethers as donors for the boron trihalidedonor complexes, the aluminum trihalide-donor complexes or the alkylaluminum halide complexes, have been found to be those in which the donor compound has a total carbon number of 3 to 16, preferably of 4 to 16, especially of 4 to 12, in particular of 4 to 8.

In another preferred embodiment halide-substituted ethers are preferred in combination with aluminum halide-donor complex or iron halide-donor complex or boron halide-donor complex.

Organic compounds with at least one carboxylic ester function are preferably hydrocarbyl carboxylates of the general formula R¹⁰—COOR¹¹ in which the variables R¹⁰ and R¹¹ are each independently C₁- to C₂₀-alkyl radicals, especially C₁- to C₈ alkyl radicals, C₅- to C₈-cycloalkyl radicals, C₆- to C₂₀-aryl radicals, especially C₆- to C₁₂ aryl radicals, or C₇- to C₂₀-arylalkyl radicals, especially C₇- to C₁₂-arylalkyl radicals.

Examples of the hydrocarbyl carboxylates mentioned are methyl formate, ethyl formate, n-pro-pyl formate, isopropyl formate, n-butyl formate, sec-butyl formate, isobutyl formate, tertbutyl formate, methyl acetate, ethyl acetate, n-propyl acetate, isopropyl acetate, n-butyl acetate, sec-butyl acetate, isobutyl acetate, tert-butyl acetate, methyl propionate, ethyl propionate, n-propyl propionate, isopropyl propionate, n-butyl propionate, sec-butyl propionate, isobutyl propionate, tert-butyl propionate, methyl butyrate, ethyl butyrate, n-propyl butyrate, isopropyl butyrate, n-bu-tyl butyrate, sec-butyl butyrate, isobutyl butyrate, tert-butyl butyrate, methyl cyclohexanecarboxylate, ethyl cyclohexanecarboxylate, n-propyl cyclohexanecarboxylate, isopropyl cyclohexane-carboxylate, n-butyl cyclohexanecarboxylate, sec-butyl cyclohexanecarboxylate, isobutyl cyclohexanecarboxylate, tert-butyl cyclohexanecarboxylate, methyl benzoate, ethyl benzoate, n-pro-pyl benzoate, isopropyl benzoate, n-butyl benzoate, sec-butyl benzoate, isobutyl benzoate, tert-butyl benzoate, methyl phenylacetate, ethyl phenylacetate, n-propyl phenylacetate, isopropyl phenylacetate, n-butyl phenylacetate, sec-butyl phenylacetate, isobutyl phenylacetate and tert-butyl phenylacetate. Among the hydrocarbyl carboxylates mentioned, ethyl acetate has been found to be particularly advantageous as a donor for the complexes.

In addition, particularly advantageous hydrocarbyl carboxylates as donors, have been found to be those in which the donor compound has a total carbon number of 3 to 16, preferably of 4 to 16, especially of 4 to 12, in particular of 4 to 8, preference is given in particular to those having a total of 3 to 10 and especially 4 to 6 carbon atoms.

Organic compounds with at least one aldehyde function, preferably exactly one aldehyde function and organic compounds with at least one keto function, preferably exactly one keto function typically have from 1 to 20, preferably from 2 to 10 carbon atoms. Functional groups other than the carbonyl group are preferably absent.

Preferred organic compounds with at least one aldehyde function are those of formula R¹⁰—CHO, in which R¹⁰ has the above-mentioned meaning, very preferably are selected from the group consisting of formaldehyde, acetaldehyde, propionaldehyde, n-butyraldehyde, isobutyraldehyde, and benzaldehyde.

Preferred organic compounds with at least one keto function are those of formula R¹⁰—(C═O)—R¹¹, in which R¹⁰ and R¹¹ have the above-mentioned meaning, very preferably are selected from the group consisting of acetone, methyl ethyl ketone, diethyl ketone, methyl isobutyl ketone, cyclohexanone, acetophenone, and benzophenone. Greatest preference is given to acetone.

Organic compounds with at least one nitrogen containing heterocyclic ring are preferably saturated, partly unsaturated or unsaturated nitrogen-containing five-membered or six-membered heterocyclic rings which comprises one, two or three ring nitrogen atoms and may have one or two further ring heteroatoms from the group of oxygen and sulphur and/or hydrocarbyl radicals, especially C₁- to C₄-alkyl radicals and/or phenyl, and/or functional groups or heteroatoms as substituents, especially fluorine, chlorine, bromine, nitro and/or cyano, for example pyrrolidine, pyrrole, imidazole, 1,2,3- or 1,2,4-triazole, oxazole, thiazole, piperidine, pyrazane, pyrazole, pyridazine, pyrimidine, pyrazine, 1,2,3-, 1,2,4- or 1,2,5-triazine, 1,2,5-oxathiazine, 2H-1,3,5-thiadiazine or morpholine.

However, a very particularly suitable nitrogen-containing basic compound of this kind is pyridine or a derivative of pyridine (especially a mono-, di- or tri-C₁- to C₄-alkyl-substituted pyridine) such as 2-, 3-, or 4-methylpyridine (picolines), 2,3-, 2,4-, 2,5-, 2,6-, 3,4-, 3,5- or 3,6-dimethylpyridine (lutidines), 2,4,6-trimethylpyridine (collidine), 2-, 3, or 4-tert-butylpyridine, 2-tert-butyl-6-methyl-pyridine, 2,4-, 2,5-, 2,6- or 3,5-di-tert-butylpyridine or else 2-, 3-, or 4-phenylpyridine.

### Initiator:

The polymerization is preferably performed with additional use of a mono- or polyfunctional, especially mono-, di- or trifunctional, initiator which is selected from organic hydroxyl compounds, organic halogen compounds and water. It is also possible to use mixtures of the initiators mentioned, for example mixtures of two or more organic hydroxyl compounds, mixtures of two or more organic halogen compounds, mixtures of one or more organic hydroxyl compounds and one or more organic halogen compounds, mixtures of one or more organic hydroxyl compounds and water, or mixtures of one or more organic halogen compounds and water. The initiator may be mono-, di- or polyfunctional, i.e. one, two or more hydroxyl groups or halogen atoms, which start the polymerization reaction, may be present in the initiator molecule. In the case of di- or polyfunctional initiators, telechelic isobutene polymers with two or more, especially two or three, polyisobutene chain ends are typically obtained.

Organic hydroxyl compounds which have only one hydroxyl group in the molecule and are suitable as monofunctional initiators include especially alcohols and phenols, in particular those of the general formula R¹²—OH, in which R¹² denotes C₁- to C₂₀-alkyl radicals, especially C₁- to C₈-alkyl radicals, C₅- to C₈-cycloalkyl radicals, C₆- to C₂₀-aryl radicals, especially C₆- to C₁₂-aryl radicals, or C₇- to C₂₀-arylalkyl radicals, especially C₇- to C₁₂-arylalkyl radicals. In addition, the R¹² radicals may also comprise mixtures of the abovementioned structures and/or have other functional groups than those already mentioned, for example a keto function, a nitroxide or a carboxyl group, and/or heterocyclic structural elements.

Typical examples of such organic monohydroxyl compounds are methanol, ethanol, n-propanol, isopropanol, n-butanol, sec-butanol, isobutanol, tert-butanol, n-pentanol, n-hexanol, n-heptanol, n-octanol, 2-ethylhexanol, cyclohexanol, phenol, p-methoxyphenol, o-, m- and p-cresol, benzyl alcohol, p-methoxybenzyl alcohol, 1- and 2-phenylethanol, 1- and 2-(p-methoxyphenyl)ethanol, 1-, 2- and 3-phenyl-1-propanol, 1-, 2- and 3-(p-methoxyphenyl)₁-propanol, 1- and 2-phenyl-2-propanol, 1- and 2-(p-methoxyphenyl)-2-propanol, 1-, 2-, 3- and 4-phenyl-1-butanol, 1-, 2-, 3- and 4-(p-methoxyphenyl)-1-butanol, 1-, 2-, 3- and 4-phenyl-2-butanol, 1-, 2-, 3- and 4-(p-me-thoxyphenyl)-2-butanol, 9-methyl-9H-fluoren-9-ol, 1,1-diphenylethanol, 1,1-diphenyl-2-propyn-1-ol, 1,1-diphenylpropanol, 4-(1-hydroxy-1-phenylethyl)benzonitrile, cyclopropyldiphenylmethanol, 1-hydroxy-1,1-diphenylpropan-2-one, benzilic acid, 9-phenyl-9-fluorenol, triphenylmethanol, diphenyl(4-pyridinyl)methanol, alpha, alpha-diphenyl-2-pyridinemethanol, 4-methoxytrityl alcohol (especially polymer-bound as a solid phase), alpha-tert-butyl-4-chloro-4′-methylbenzhydrol, cyclohexyldiphenylmethanol, alpha-(p-tolyl)-benzhydrol, 1,1,2-triphenylethanol, alpha,alpha-diphenyl-2-pyridineethanol, alpha,alpha-4-pyridylbenzhydrol N-oxide, 2-fluorotriphenylmethanol, triphenylpropargyl alcohol, 4-[(diphenyl)hydroxymethyl]benzonitrile, 1-(2,6-dimethoxyphenyl)-2-methyl-1-phenyl-1-propanol, 1,1,2-triphenylpropan-1-ol and p-anisaldehyde carbinol.

In a preferred embodiment it is possible to use a mixture of primary and secondary alcohols as initiators, as described in WO 2013/120859.

Organic hydroxyl compounds which have two hydroxyl groups in the molecule and are suitable as bifunctional initiators are especially dihydric alcohols or diols having a total carbon number of 2 to 30, especially of 3 to 24, in particular of 4 to 20, and bisphenols having a total carbon number of 6 to 30, especially of 8 to 24, in particular of 10 to 20, for example ethylene glycol, 1,2- and 1,3-propylene glycol, 1,4-butylene glycol, 1,6-hexylene glycol, 1,2-, 1,3- or 1,4-bis(1-hydroxy-1-methylethyl)benzene (o-, m- or p-dicumyl alcohol), bisphenol A, 9,10-dihydro-9,10-dimethyl-9,10-anthracenediol, 1,1-diphenylbutane-1,4-diol, 2-hydroxytriphenylcarbinol and 9-[2-(hydroxymethyl)phenyl]-9-fluorenol.

Organic halogen compounds which have one halogen atom in the molecule and are suitable as monofunctional initiators are in particular compounds of the general formula R¹³—Hal in which Hal is a halogen atom selected from fluorine, iodine and especially chlorine and bromine, and R¹³ denotes C₁- to C₂₀-alkyl radicals, especially C₁- to C₈-alkyl radicals, C₅- to C₈-cycloalkyl radicals or C₇- to C₂₀-arylalkyl radicals, especially C₇- to C₁₂-arylalkyl radicals. In addition, the R¹³ radicals may also comprise mixtures of the abovementioned structures and/or have other functional groups than those already mentioned, for example a keto function, a nitroxide or a carboxyl group, and/or heterocyclic structural elements.

Typical examples of such monohalogen compounds are methyl chloride, methyl bromide, ethyl chloride, ethyl bromide, 1-chloropropane, 1-bromopropane, 2-chloropropane, 2-bromopropane, 1-chlorobutane, 1-bromobutane, sec-butyl chloride, sec-butyl bromide, isobutyl chloride, isobutyl bromide, tert-butyl chloride, tert-butyl bromide, 1-chloropentane, 1-bromopentane, 1-chloro-hexane, 1-bromohexane, 1-chloroheptane, 1-bromoheptane, 1-chlorooctane, 1-bromooctane, 1-chloro-2-ethylhexane, 1-bromo-2-ethylhexane, cyclohexyl chloride, cyclohexyl bromide, benzyl chloride, benzyl bromide, 1-phenyl-1-chloroethane, 1-phenyl-1-bromoethane, 1-phenyl-2-chloro-ethane, 1-phenyl-2-bromoethane, 1-phenyl-1-chloropropane, 1-phenyl-1-bromopropane, 1-phe-nyl-2-chloropropane, 1-phenyl-2-bromopropane, 2-phenyl-2-chloropropane, 2-phenyl-2-bromo-propane, 1-phenyl-3-chloropropane, 1-phenyl-3-bromopropane, 1-phenyl-1-chlorobutane, 1-phenyl-1-bromobutane, 1-phenyl-2-chlorobutane, 1-phenyl-2-bromobutane, 1-phenyl-3-chloro-butane, 1-phenyl-3-bromobutane, 1-phenyl-4-chlorobutane, 1-phenyl-4-bromobutane, 2-phenyl-1-chlorobutane, 2-phenyl-1-bromobutane, 2-phenyl-2-chlorobutane, 2-phenyl-2-bromobutane, 2-phenyl-3-chlorobutane, 2-phenyl-3-bromobutane, 2-phenyl-4-chlorobutane and 2-phenyl-4-bromobutane.

Organic halogen compounds which have two halogen atoms in the molecule and are suitable as difunctional initiators are, for example, 1,3-bis(1-bromo-1-methylethyl)benzene, 1,3-bis(2-chloro-2-propyl)benzene (1,3-dicumyl chloride) and 1,4-bis(2-chloro-2-propyl)benzene (1,4-dicumyl chloride).

The initiator is more preferably selected from organic hydroxyl compounds in which one or more hydroxyl groups are each bonded to an sp³-hybridized carbon atom, organic halogen compounds, in which one or more halogen atoms are each bonded to an sp³-hybridized carbon atom, and water. Among these, preference is given in particular to an initiator selected from organic hydroxyl compounds in which one or more hydroxyl groups are each bonded to an sp³-hybridized carbon atom.

In the case of the organic halogen compounds as initiators, particular preference is further given to those in which the one or more halogen atoms are each bonded to a secondary or especially to a tertiary sp³-hybridized carbon atom.

Preference is given in particular to initiators which may bear, on such an sp³-hybridized carbon atom, in addition to the hydroxyl group, the R¹², R¹³ and R¹⁴ radicals, which are each independently hydrogen, C₁- to C₂₀-alkyl, C₅- to C₈-cycloalkyl, C₆- to C₂₀-aryl, C₇- to C₂₀-alkylaryl or phenyl, where any aromatic ring may also bear one or more, preferably one or two, C₁- to C₄-alkyl, C₁- to C₄-alkoxy, C₁- to C₄-hydroxyalkyl or C₁- to C₄-haloalkyl radicals as substituents, where not more than one of the variables R¹², R¹³ and R¹⁴ is hydrogen and at least one of the variables R¹², R¹³ and R¹⁴ is phenyl which may also bear one or more, preferably one or two, C₁- to C₄-alkyl, C₁- to C₄-alkoxy, C₁- to C₄-hydroxyalkyl or C₁- to C₄-haloalkyl radicals as substituents.

For the present invention, very particular preference is given to initiators selected from water, methanol, ethanol, 1-phenylethanol, 1-(p-methoxyphenyl)ethanol, n-propanol, isopropanol, 2-phenyl-2-propanol (cumene), n-butanol, isobutanol, sec.-butanol, tert-butanol, 1-phenyl-1-chloroethane, 2-phenyl-2-chloropropane (cumyl chloride), tert-butyl chloride and 1,3- or 1,4-bis(1-hydroxy-1-methylethyl)benzene. Among these, preference is given in particular to initiators selected from water, methanol, ethanol, 1-phenylethanol, 1-(p-methoxyphenyl)ethanol, n-pro-panol, isopropanol, 2-phenyl-2-propanol (cumene), n-butanol, isobutanol, sec.-butanol, tert-butanol, 1-phenyl-1-chloroethane and 1,3- or 1,4-bis(1-hydroxy-1-methylethyl)benzene.

Special preference is given to water.

### Starting Material for Polymerisation

For the use of isobutene or of an isobutene-comprising monomer mixture as the monomer to be polymerized, suitable isobutene sources are both pure isobutene and isobutenic C₄ hydrocarbon streams, for example C₄ raffinates, especially “raffinate 1”, C₄ cuts from isobutane dehydrogenation, C₄ cuts from steam crackers and from FCC crackers (fluid catalyzed cracking), provided that they have been substantially freed of 1,3-butadiene present therein. A C₄ hydrocarbon stream from an FCC refinery unit is also known as “b/b” stream. Further suitable isobutenic C₄ hydrocarbon streams are, for example, the product stream of a propylene-isobutane cooxidation or the product stream from a metathesis unit, which are generally used after customary purification and/or concentration. Suitable C₄ hydrocarbon streams generally comprise less than 500 ppm, preferably less than 200 ppm, of butadiene. The presence of 1-butene and of cis- and trans-2-butene is substantially uncritical. Typically, the isobutene concentration in the C₄ hydrocarbon streams mentioned is in the range from 40 to 60% by weight. For instance, raffinate 1 generally consists essentially of 30 to 50% by weight of isobutene, 10 to 50% by weight of 1-butene, 10 to 40% by weight of cis- and trans-2-butene, and 2 to 35% by weight of butanes; in the polymerization process according to the invention, the unbranched butenes in the raffinate 1 generally behave virtually inertly, and only the isobutene is polymerized.

In a preferred embodiment, the monomer source used for the polymerization is a technical C₄ hydrocarbon stream with an isobutene content of 1 to 100% by weight, especially of 1 to 99% by weight, in particular of 1 to 90% by weight, more preferably of 30 to 60% by weight, especially a raffinate 1 stream, a b/b stream from an FCC refinery unit, a product stream from a propylene-isobutane cooxidation or a product stream from a metathesis unit.

Especially when a raffinate 1 stream is used as the isobutene source, the use of water as the sole initiator or as a further initiator has been found to be useful, in particular when polymerization is effected at temperatures of −20° C. to +30° C., especially of 0° C. to +20° C. At temperatures of −20° C. to +30° C., especially of 0° C. to +20° C., when a raffinate 1 stream is used as the isobutene source, it is, however, also possible to dispense with the use of an initiator.

The isobutenic monomer mixture mentioned may comprise small amounts of contaminants such as water, carboxylic acids or mineral acids, without there being any critical yield or selectivity losses. It is appropriate to prevent enrichment of these impurities by removing such harmful substances from the isobutenic monomer mixture, for example by adsorption on solid adsorbents such as activated carbon, molecular sieves or ion exchangers.

It is also possible to convert monomer mixtures of isobutene or of the isobutenic hydrocarbon mixture with olefinically unsaturated monomers copolymerizable with isobutene. When monomer mixtures of isobutene are to be copolymerized with suitable comonomers, the monomer mixture preferably comprises at least 5% by weight, more preferably at least 10% by weight and especially at least 20% by weight of isobutene, and preferably at most 95% by weight, more preferably at most 90% by weight and especially at most 80% by weight of comonomers.

Useful copolymerizable monomers include: vinylaromatics such as styrene and α-methylstyrene, C₁- to C₄-alkylstyrenes such as 2-, 3- and 4-methylstyrene, and 4-tertbutylsty-rene, halostyrenes such as 2-, 3- or 4-chlorostyrene, and isoolefins having 5 to 10 carbon atoms, such as 2-methylbutene-1, 2-methylpentene-1, 2-methylhexene-1, 2-ethylpentene-1, 2-ethylhexene-1 and 2-propylheptene-1. Further useful comonomers include olefins which have a silyl group, such as 1-trimethoxysilylethene, 1-(trimethoxysilyl)propene, 1-(trimethoxysilyl)-2-methylpropene-2, 1-[tri(methoxyethoxy)-silyl]ethene, 1-[tri(methoxyethoxy)silyl]propene, and 1-[tri(methoxyethoxy)silyl]-2-methylpro-pene-2. In addition—depending on the polymerization conditions—useful comonomers also include isoprene, 1-butene and cis- and trans-2-butene.

When the process according to the invention is to be used to prepare copolymers, the process can be configured so as to preferentially form random polymers or to preferentially form block copolymers. To prepare block copolymers, for example, the different monomers can be supplied successively to the polymerization reaction, in which case the second comonomer is especially not added until the first comonomer is already at least partly polymerized. In this manner, diblock, triblock and higher block copolymers are obtainable, which, according to the sequence of monomer addition, have a block of one or the other comonomer as a terminal block. In some cases, however, block copolymers also form when all comonomers are supplied to the polymerization reaction simultaneously, but one of them polymerizes significantly more rapidly than the other(s). This is the case especially when isobutene and a vinylaromatic compound, especially styrene, are copolymerized in the process according to the invention. This preferably forms block copolymers with a terminal polystyrene block. This is attributable to the fact that the vinylaromatic compound, especially styrene, polymerizes significantly more slowly than isobutene.

The polymerization can be effected either continuously or batchwise. Continuous processes can be performed in analogy to known prior art processes for continuous polymerization of isobutene in the presence of boron trifluoride-based catalysts in the liquid phase.

The process according to the invention is suitable either for performance at low temperatures, e.g. at −90° C. to 0° C., or at higher temperatures, i.e. at least 0° C., e.g. at 0° C. to +30° C. or at 0° C. to +50° C. The polymerization in the process according to the invention is, however, preferably performed at relatively low temperatures, generally at −70° C. to −10° C., especially at −60° C. to −15° C.

When the polymerization in the process according to the invention is effected at or above the boiling temperature of the monomer or monomer mixture to be polymerized, it is preferably performed in pressure vessels, for example in autoclaves or in pressure reactors.

The polymerization in the process may be performed in the presence of an inert diluent. The inert diluent used should be suitable for reducing the increase in the viscosity of the reaction solution which generally occurs during the polymerization reaction to such an extent that the removal of the heat of reaction which evolves can be ensured. Suitable diluents are those solvents or solvent mixtures which are inert toward the reagents used. Suitable diluents are, for example, aliphatic hydrocarbons such as n-butane, n-pentane, n-hexane, n-heptane, n-octane and isooctane, cycloaliphatic hydrocarbons such as cyclopentane and cyclohexane, aromatic hydrocarbons such as benzene, toluene and the xylenes, and halogenated hydrocarbons, especially halogenated aliphatic hydrocarbons, such as methyl chloride, dichloromethane and trichloromethane (chloroform), 1,1-dichloroethane, 1,2-dichloroethane, trichloroethane and 1-chlorobutane, and also halogenated aromatic hydrocarbons and alkylaromatics halogenated in the alkyl side chains, such as chlorobenzene, monofluoromethylbenzene, difluoromethylbenzene and trifluoromethylbenzene, and mixtures of the aforementioned diluents. The diluents used, or the constituents used in the solvent mixtures mentioned, are also the inert components of isobutenic C₄ hydrocarbon streams. A non-halogenated solvent is preferred over the list of halogenated solvents.

The polymerization may be performed in a halogenated hydrocarbon, especially in a halogenated aliphatic hydrocarbon, or in a mixture of halogenated hydrocarbons, especially of halogenated aliphatic hydrocarbons, or in a mixture of at least one halogenated hydrocarbon, especially a halogenated aliphatic hydrocarbon, and at least one aliphatic, cycloaliphatic or aromatic hydrocarbon as an inert diluent, for example a mixture of dichloromethane and n-hexane, typically in a volume ratio of 10:90 to 90:10, especially of 50:50 to 85:15. Prior to use, the diluents are preferably freed of impurities such as water, carboxylic acids or mineral acids, for example by adsorption on solid adsorbents such as activated carbon, molecular sieves or ion exchangers.

In a preferred embodiment, the polymerization is performed in halogen-free aliphatic or especially halogen-free aromatic hydrocarbons, especially toluene. For this embodiment, water in combination with the organic hydroxyl compounds mentioned and/or the organic halogen compounds mentioned, or especially as the sole initiator, have been found to be particularly advantageous.

In another preferred embodiment, the polymerization is performed in halogen-free aliphatic or cycloaliphatic, preferably aliphatic hydrocarbons, especially hexane, pentane, heptane, cyclohexane, cyclopentane, and mixtures comprising them.

The polymerization is preferably performed under substantially aprotic and especially under substantially anhydrous reaction conditions. Substantially aprotic and substantially anhydrous reaction conditions are understood to mean that, respectively, the content of protic impurities and the water content in the reaction mixture are less than 50 ppm and especially less than 5 ppm. In general, the feedstocks will therefore be dried before use by physical and/or chemical measures. More particularly, it has been found to be useful to admix the aliphatic or cycloaliphatic hydrocarbons used as solvents, after customary prepurification and predrying with an organometallic compound, for example an organolithium, organomagnesium or organoaluminum compound, in an amount which is sufficient to substantially remove the water traces from the solvent. The solvent thus treated is then preferably condensed directly into the reaction vessel. It is also possible to proceed in a similar manner with the monomers to be polymerized, especially with isobutene or with the isobutenic mixtures. Drying with other customary desiccants such as molecular sieves or predried oxides such as aluminum oxide, silicon dioxide, calcium oxide or barium oxide is also suitable. The halogenated solvents for which drying with metals such as sodium or potassium or with metal alkyls is not an option are freed of water or water traces with desiccants suitable for that purpose, for example with calcium chloride, phosphorus pentoxide or molecular sieves. It is also possible in an analogous manner to dry those feedstocks for which treatment with metal alkyls is likewise not an option, for example vinylaromatic compounds. Even if some or all of the initiator used is water, residual moisture should preferably be very substantially or completely removed from solvents and monomers by drying prior to reaction, in order to be able to use the water initiator in a controlled, specified amount, as a result of which greater process control and reproducibility of the results are obtained.

The polymerization reaction is appropriately terminated by adding excess amounts of water or of basic material, for example gaseous or aqueous ammonia or aqueous alkali metal hydroxide solution such as sodium hydroxide solution.

After unconverted C₄ monomers have been removed, the crude polymerization product is typically washed repeatedly with distilled or deionized water, in order to remove adhering inorganic constituents. To achieve high purities or to remove undesired low and/or high molecular weight fractions, the polymerization reaction mixture can be fractionally distilled under reduced pressure.

The thus obtainable polyisobutene composition with a content of polyisobutene species (A) bearing an alpha-double bond of at least 70 mol % is subjected to the double bond isomerisation process described below.

It is also possible to use the reaction mixture from the polymerisation after desactivation of the catalyst and optionally after removal of the hydrolysis products by washing in the double bond isomerisation process without further purification. Besides the polyisobutene composition with a content of polyisobutene species (A) bearing an alpha-double bond of at least 70 mol % such a reaction mixture may contain unreacted monomer and lower oligomers of isobutene.

The undistilled reaction mixture differs from the polyisobutene composition insofar that it additionally comprises isobutene and those lower oligomers of isobutene which are usually separated from the reaction mixture by distillation.

Such lower oligomers of isobutene can be diisobutene, triisobutene, tetraisobutene, pentaisobutene, hexaisobutene, heptaisobutene, and octaisobutene. Higher oligomers of isobutene usually remain in the polyisobutene composition since they are not significantly volatile under distillation conditions, even under reduced pressure.

The content of unreacted isobutene may be up to 12 wt %, preferably up to 10 wt %, more preferably up to 5 wt %.

The content of unreacted lower oligomers mentioned above may be up to 5 wt %, preferably up to 3 wt %.

The distribution of double bond isomers (A), (B), and (C) among the oligomers is usually comparable to that of the polymer mixture, preferably it is the same. However, it has been observed that oligomer mixtures comprise less of isomer (C6) compared with polymer mixtures, sometimes up to 5 mol % of isomer (C6) less.

Hence, the content of oligomer species of formula (A) bearing an alpha-double bond is at least 70 mol %, preferably at least 75 mol %, more preferably at least 80 mol %, most preferably at least 85 mol % and especially at least 90 mol %.

For the isomerisation process it is possible to use a solution of the polyisobutene composition in at least one solvent as described above or to use the polyisobutene composition neat.

In a preferred embodiment a 10 to 90 wt % solution of the polyisobutene composition in a solvent, preferably in a halid-free solvent is used in the double bond isomerisation process, preferably a 20 to 80 wt % solution, more preferably a 30 to 70, and especially 40 to 60 wt % solution.

In one embodiment the solvent may be the inert components of isobutenic C₄ hydrocarbon streams.

After being subjected to the double bond isomerisation process the solvent in the reaction mixture is preferably removed, more preferably removed by way of distillation.

Usually a single step evaporation is sufficient without rectification equipment and can be effected in a falling-film evaporator, a rising-film evaporator, a thin-film evaporator, a long-tube evaporator, a helical tube evaporator, a forced-circulation flash evaporator or a paddle dryer, for example a Discotherm® dryer from List Technology AG, Switzerland, or a combination of these apparatuses.

The distillation is effected, as a rule, at 80-320° C., preferably 100-300° C., and 0.1-40, preferably 0.5-20 mbar.

Distillation may be assisted by leading an inert stripping through the evaporator, preferably nitrogen.

### Isomerisation Process

According to the present invention a polyisobutene composition with a content of polyisobutene species (A) bearing an alpha-double bond of at least 70 mol % is contacted with at least one acidic solid state catalyst, optionally treated with at least one Brønsted-base, and converted into a polyisobutene composition with a content of polyisobutene species (B) bearing a vinylidene beta-double bond of more than 35 to 80 mol %, preferably 40 to 70, more preferably 45 to 65 and most preferably 50 to 60 mol %.

With the process according to the invention usually 5 to 60%, preferably 20 to 50% (relative to the starting value) of the polyisobutene species (A) bearing an alpha-double bond are converted into polyisobutene species (B) bearing a vinylidene beta-double bond.

Optionally such a composition may comprise up to 20 mol % (in sum) polyisobutene isomers (C) and (D) other than (A) and (B), wherein the sum of (A), (B), (C), and (D) always adds up to 100 mol %.

The above-mentioned process is carried out at a temperature of from 40° C. to 250° C., preferably 50 to 230, more preferably 60 to 200, even more preferably 70 to 180 and especially 80 to 160° C. for a period of from 10 minutes to 36 hours, preferably 15 minutes to 24 hours, more preferably 30 minutes to 12 hours, and especially 1 to 6 hours.

Optimum contact time of the polyisobutene composition with the catalyst and reaction temperature can be determined by systematic variation of the reaction parameters.

Examples of acidic solid state catalysts are those which exhibit a temperature programmed desorption (TPD) of ammonia which is above the physical adsorption. A method for the determination of the temperature programmed desorption (TPD) of ammonia can be found in Philip M. Kester, Jeffrey T. Miller, and Rajamani Gounder, Ammonia Titration Methods To Quantify Brønsted Acid Sites in Zeolites Substituted with Aluminum and Boron Heteroatoms, Industrial & Engineering Chemistry Research 2018 57(19), 6673-6683, Chapter 2.3.

Preferably the acidic solid state catalysts are selected from the group consisting of
Natural clay minerals: kaolinite, bentonite, attapulgite, montmorillonite, clarit, fuller's earth, zeolites (X, Y, A, H-ZSM etc), cation exchanged zeolites, and clays
Mounted acids: H₂SO₄, H₃PO₄, CH₂(COOH)₂ mounted on silica, quartz sand, alumina or diatomaceous earth
Cation exchange resins
Metal oxides and sulfides: ZnO, CdO, Al₂O₃, CeO₂, ThO₂, TiO₂, ZrO₂, SnO₂, PbO, As₂O₅, Bi₂O₃, Sb₂O₅, V₂O₅, Cr₂O₃, MoO₃, WO₃, CdS, ZnS
Metal salts: MgSO₄, CaSO₄, SrSO₄, BaSO₄, CuSO₄, ZnSO₄, CdSO₄, Al₂(SO₄)₃, FeSO₄, Fe₂(SO₄)₃, CoSO₄, NiSO₄, Cr₂(SO₄)₃, KHSO₄, K₂SO₄, (NH₄)₂SO₄, Zn(NO₃)₂, Ca(NO₃)₂, Bi(NO₃)₃, Fe(NO₃)₃, CaCO₃, BPO₄, AIPO₄, CrPO₄, FePO₄, Cu₃(PO₄)₂, Zn₃(PO₄)₂, Mg₃(PO₄)₂, Ti₃(PO₄)₄, Zr₃(PO₄)₄, Ni₃(PO₄)₂, AgCl, CuCl, CaCl₂, AlCl₃, TiCl₄, SnCl₄, CaF₂, BaF₂, AgClO₄, Mg(ClO₄)₂,
Mixed oxides: SiO₂—Al₂O₃, SiO₂—TiO₂, SiO₂—SnO₂, SiO₂—ZrO₂, SiO₂—BeO, SiO₂—MgO, SiO₂—CaO, SiO₂—SrO, SiO₂—ZnO, SiO₂—Ga₂O₃, SiO₂—Y₂O₃, SiO₂—La₂O₃, SiO₂—MoO₃, SiO₂—WO₃, SiO₂—V₂O₅, SiO₂—ThO₂, Al₂O, —MgO, Al₂O₃—ZnO, Al₂O₃—CdO, Al₂O₃—B₂O₃, Al₂O₃—ThO₂, Al₂O₃—TiO₂, Al₂O₃—ZrO₂, Al₂O₃—V₂O₅, Al₂O₃—MoO₃, Al₂O₃—WO₃, Al₂O₃—Cr₂O₃, Al₂O₃—Mn₂O₃, Al₂O₃—Fe₂O₃, Al₂O₃—Co₃O₄, Al₂O₃—NiO, TiO₂—CuO, TiO₂—MgO, TiO₂—ZnO, TiO₂—CdO, TiO₂—ZrO₂, TiO₂—SnO₂, TiO₂—Bi₂O₃, TiO₂—Sb₂O₅, TiO₂—V₂O₅, TiO₂—Cr₂O₃, TiO₂—MoO₃, TiO₂—WO₃, TiO₂—Mn₂O₃, TiO₂—Fe₂O₃, TiO₂—Co₃O₄, TiO₂—NiO, ZrO₂—CdO, ZnO—MgO, ZnO—Fe₂O₃, MoO₃—CoO—Al₂O₃, MoO₃—NiO—Al₂O₃, TiO₂—SiO₂—MgO, MoO₃—Al₂O₃—MgO, heteropoly acids.

More preferably the acidic solid state catalyst is selected from the group consisting of SiO₂, Al₂O₃, TiO₂, ZrO₂, B₂O₃, ZnO₂, Nb₂O₅ or mixtures thereof.

Very preferably the acidic solid state catalyst is selected from the group consisting of silicates, alumina, silico-aluminates, and zeolites.

Especially the acidic solid state catalyst is a molecular sieve.

The average pore diameter of such molecular sieves is from 0.1 to 1 nm (1 to 10 Å), preferably from 0.1 to 0.6, more preferably from 0.2 to 0.5 nm.

Such molecular sieves are aluminosilicates with a silica-alumina ratio (SiO₂/Al₂O₃) of from 1 0.1 to 1:5, preferably from 1:0.2 to 1:3, and more preferably of 1:0.2 to 1:1, especially 1:0.5.

The approximate chemical composition of such aluminosilicates is

[(K₂O)ₓ(Na₂O)_{y}]·Al₂O₃·2SiO₂·9/2H₂O

with
x from 0 to 1, preferably from 0 to 0.7, more preferably from 0 to 0.5, especially 0, y from 0 to 1, preferably from 0.3 to 1, more preferably from 0.5 to 1, especially 1, wherein x+y=1.

In a preferred embodiment the acidity of the acidic solid state catalysts is adjusted by treatment with at least one Brønsted-base, preferably at least one inorganic base, more preferably hydroxides, oxides, C₁-C₄-carboxylates, preferably formiates or acetates, more preferably acetates, carbonates or hydrogen carbonates of alkaline or earth alkaline metals, even more preferably of sodium, potassium or calcium.

For this purpose the acidic solid state catalyst is treated with an aqueous solution of the Brønsted-base in an amount sufficient to yield the desired acidity, and afterwards dried or calcinated.

Preferably the impregnated solid state catalyst is calcinated at a temperature of from 400 to 1000° C.

With such a treatment it is possible to adjust the acidity and, therefore, the reactivity of a solid state catalyst so that the reaction can be terminated when the concentration of the desired isomer (B) in the reaction mixture is at its maximum while side- or follow up-reactions-do not occur significantly.

In a preferred embodiment the solid state catalyst comprises an alumina component, a zeolite component and optionally an added metal component as the Brønsted-base, preferably the added metal component is present in the solid state catalyst. In a preferred embodiment the solid state catalyst is used as described in U.S. Pat. No. 8,147,588 B2, preferably as described therein from column 2, line 50 to column 5, line 32, which is incorporated herein by reference.

The acidic solid state catalyst, optionally treated with at least one Brønsted-base can be used in different geometrical shapes, such as powder, granules, beads, spheres, saddles, extrudates, strands, pellets, tablets or meshs.

The catalyst load, calculated as kg polyisobutene composition per kg solid state catalyst and hour reaction time, can vary from 0.1 to 10, preferably from 0.2 to 8, more preferably from 0.5 to 5 kg/(kg×h).

In a preferred embodiment the process according to the invention is conducted in the presence of at least one initiator compound described above, more preferably in the presence of water or at least one organic hydroxyl compound, and very preferably in the presence of water.

For this purpose the polyisobutene composition with a content of polyisobutene species (A) as a starting material is contacted with the acidic solid state catalyst, optionally treated with at least one Brønsted-base in the presence of up to 5 wt % (relative to the polyisobutene species (A)) of the at least one initiator, preferably up to 3 wt %, more preferably up to 2 wt %, and especially up to 1 wt %.

The process can optionally be conducted in the presence of at least one solvent, preferably in the presence of at least one solvent.

As solvent those solvents may be used which are listed above in the context of the polymerisation, preferred are non-halogenated solvents, more preferred are aliphatic or aromatic hydrocarbons, especially aliphatic hydrocarbons.

In a preferred embodiment the solvent, especially the hydrocarbon, is treated with water, preferably saturated with water prior to conducting the isomerisation reaction and the reaction is thus conducted in the presence of a solvent together with water.

The isomerisation process can be conducted in a continuous or discontinuous manner, preferably continuously.

For a discontinuous reaction polyisobutene composition, optional solvent, and solid state catalyst are placed together in a reactor, heated to the temperature desired and the reaction is conducted under stirring or pumping the reaction mixture in a circular flow.

For a continuous reaction polyisobutene composition, optional solvent, and solid state catalyst are conveyed through a reactor in upflow or downflow procedure, heated to the temperature desired and the reaction is conducted. The liquid flow through the reactor is adjusted so that the residence time in the reactor corresponds to the reaction time desired.

Usually the reaction can be conducted at atmospheric pressure, higher pressure may be helpful to prevent the optional solvent from evaporating so that the reaction mixture remains in a single liquid phase.

The Langmuir specific surface area of the acidic solid state catalyst, optionally treated with at least one Brønsted-base, employed in the process according to the invention is preferably from 50 to 1000 m²/g, more preferably from 75 to 900 m²/g, particularly preferably from 100 to 800 m²/g, even more preferably 200 to 700, and especially 300 to 500 m²/g. The Langmuir surface area is determined by nitrogen absorption using the DIN 66132 method.

The pore volume of the acidic solid state catalyst, optionally treated with at least one Brønsted-base, determined by mercury porosimetry is preferably from 0.01 to 0.3 ml/g, more preferably from 0.03 to 0.2 ml/g. The average pore diameter determined by this method is preferably from 0.1 to 10 nm, more preferably from 0.2 to 9 nm, and more preferably from 0.3 to 5 nm.

The mercury pore volume and the pore diameter of pores with 0.3 nm or higher are determined by the DIN 66133 method, for smaller pore diameters the nitrogen pore volume is used.

The acidity/basicity of the solid state catalyst is determined using the pH-value of an aqueous slurry of the solid state catalyst, see below in the Analytical Method section.

Preferred solid state catalysts without treatment with a Brønsted-base exhibit a pH-value in the form of a 10 wt % aqueous slurry from 3 to 8, preferably from 3.5 to 7, more preferably from 4 to 6, and especially from 4 to 5.5.

Preferred solid state catalysts treated with at least one Brønsted-base exhibit a pH-value in the form of a 10 wt % aqueous slurry from 6 to 13, preferably from 7 to 12.5, more preferably from 8 to 12, and especially from 9 to 11.5.

Surprisingly the process according to the present invention yields compositions with an increased content of polyisobutene species (B) bearing a vinylidene beta-double bond, although the above-mentioned reference of R. Faust et al. suggests that such isomers are higher in energy and, therefore, their formation should be less advantageous for reasons of thermodynamics.

Such compositions with an increased content of polyisobutene species (B) bearing a vinylidene beta-double bond are of sufficient reactivity both in photo oxygenation as well in a thermal reactions and, therefore, provide an excellent use as starting materials for chemical modification of such compositions, regardless whether such chemical modification is a photo reaction or a thermal reaction.

Such compositions are especially useful for photo oxygenations, but are also of sufficient reactivity for thermal chemical reactions, especially epoxidation, hydroformylation, and ene-reaction with maleic anhydride.

The NMR spectroscopy of the polyisobutene polymers was performed as described in Guo et al., Journal or Polymer Science, Part A: Polymer Chemistry, 2013, 51, 4200-4212, on a Bruker 400 MHz spectrometer using 5 mm o.d. tubes with sample concentrations of 15% (w/v) in deuterated chloroform (CDCl₃) as a solvent at 25° C. The ¹H and ¹³C NMR spectra of polyisobutene solutions in CDCl₃ were calibrated to tetramethylsilane as internal standard (δ_{H}=0.00) or to the solvent signal (δ_{C}=77.0), respectively. The distortionless enhancement by polarization transfer (DEPT) technique was further used for structural characterization of polyisobutenes.

The examples which follow are intended to illustrate the present invention in detail without restricting it.

### EXAMPLES

### Analytical Method

For quantification of the corresponding olefinic end groups 1H NMR in deuterated chloroform (CDCl₃) on a 400 MHz NMR instrument was performed. Here, the ratio between normalized integral areas of selected polyisobutene end group and the normalized sum of all integral areas originated from the olefinic species was used for the calculation. The integration areas are provided in the table below.

| Olefin | Integration range/ppm |
|---|---|
| trisubstituted olefins C1, C2, B, C7 | 5,090-5,240 and 5,290-5,430 |
| B | 5,128-5,170 |
| alpha olefins A, C6, C8 | 4,550-4,920 |
| tetrasubstituted olefins C3, C4, C5 | 2,740-2,950 |

For the determination of acidity or basicity of the solid state catalyst a slurry of 10 wt % of the solid state catalyst in ion-free water was stirred and the pH-value of the slurry measured at 25° C. with a pH electrode.

### Synthetic Examples

### Starting Materials

In the isomerization examples a highly-reactive polyisobutene with an average number-average molecular weight of approx. 1000 g/mol (commercially available as “Glissopal® 1000” from BASF) was used.

According to NMR-analysis the starting material comprises
alpha olefins A, C6, and C8 (in sum): 87.1 mol %
trisubstituted olefins C1, C2, B, and C7 (in sum): 11.4 mol %,
other isomers:
   tetrasubstituted isomers (C3), (C4) and (C5) (in sum) 1.5 mol %
   trisubstituted isomer (B) 8.7 mol %.

As solid state catalysts were used:

Molecular Sieve with the Pore Size Given in the Table
Alumina 1, zeolit-containing, alumina-based adsorbent, commercially available from BASF, surface area 400 m²/g, ⅛″ spheres, 95.1% alumina, pH-value of the slurry: 9.8
Alumina 2, zeolit-containing, alumina-based adsorbent, commercially available from BASF, surface area 450 m²/g, 7×14 mesh, 95.5% alumina, pH-value of the slurry: 10.1. Reactivity was moderated by impregnation with sodium carbonate solution before calcification.
Alumina 3, spherical alumina-zeolite composite, surface area 390 m²/g, pH-value of the slurry: 11.3

### General Procedure

40 g of n-heptane were shaken with water and phase separated to obtain an n-heptane saturated with water.

40 g of the polyisobutene starting material were mixed with water-saturated n-heptane, and mixed with the amount of solid state catalyst stated in the tables below in a flask and held at the temperature given under stirring.

Samples were taken every hour, solids filtered off by filtration, the heptane removed in vacuo (150° C., 2 mbar), and the residue analysed by ¹H-NMR and the molecular weight was determined.

The residue after the end of the reaction was treated in the same manner, however, the solids in the flask were extracted twice with n-heptane in order to remove adhering product mixture.

### Example 1

Solid state catalyst: 33 g alumina 1 (dried over night at 140° C.) and 33 g molecular sieve 5 Å (dried over night at 140° C. in vacuo)
Temperature: 80° C. for 6 hours

TABLE 1

| | | | trisubstituted | tetrasubstituted | |
|---|---|---|---|---|---|
| Isomers | alpha olefins | | olefins C1, | olefins | Mn |
| [mol %] | A, C6, C8 | (B) | C2, B, C7 | C3, C4, C5 | [g/mol] |
| starting | 87.1 | 8.7 | 11.4 | 1.5 | 1030 |
| material | | | | | |
| 1 h | 38.8 | 45 | 54.6 | 6.6 | 1100 |
| 2 h | 33.3 | 44.8 | 56.8 | 9.9 | 1110 |
| 3 h | 31.1 | 42.1 | 56.2 | 12.7 | 1120 |
| 4 h | 28.7 | 40.1 | 54.7 | 16.6 | 1150 |
| 5 h | 26.8 | 37.8 | 52.6 | 20.6 | 1080 |
| 6 h | 25 | 34.6 | 51 | 24 | 1050 |

It can easily be seen that the formation of the desired beta-isomer (B) is reaches its maximum after approx. 1 to 2 hours of reaction and decreases afterwards. In contrast the amount of tetra-substituted isomers (C3), (C4), and (C5) (in sum) increases continuously over the reaction time which supports the findings of Faust et al. that the tetra-substituted isomers are thermodynamically most favourable while the formation of the desired beta-isomer (B) obviously takes place under kinetic control.

### Example 2

Solid state catalyst: 24.76 g alumina 1 (dried over night at 140° C.) and 24.76 g molecular sieve 5 Å (dried over night at 140° C. in vacuo)
Temperature: 80° C. for 3 hours

TABLE 2

| | | | trisubstituted | tetrasubstituted | |
|---|---|---|---|---|---|
| Isomers | alpha olefins | | olefins C1, | olefins | Mn |
| [mol %] | A, C6, C8 | (B) | C2, B, C7 | C3, C4, C5 | [g/mol] |
| starting | 87.1 | 8.7 | 11.4 | 1.5 | 1030 |
| material | | | | | |
| 0.5 h | 50.2 | 37.8 | 45.8 | 4 | 1120 |
| 1 h | 39.4 | 45.5 | 55.2 | 5.4 | 1060 |
| 2 h | 33.8 | 45.2 | 57.6 | 8.6 | 1050 |
| 3 h | 31.2 | 43.1 | 56.5 | 12.3 | 1070 |

### Example 3

Solid state catalyst: 24.76 g alumina 1 (dried over night at 140° C.) and 24.76 g molecular sieve 5 Å (dried over night at 140° C. in vacuo)
Temperature: 90° C. for 3 hours

TABLE 3

| | | | trisubstituted | tetrasubstituted | |
|---|---|---|---|---|---|
| Isomers | alpha olefins | | olefins C1, | olefins | Mn |
| [mol %] | A, C6, C8 | (B) | C2, B, C7 | C3, C4, C5 | [g/mol] |
| starting | 87.1 | 8.7 | 11.4 | 1.5 | 1030 |
| material | | | | | |
| 0.5 h | 45 | 41.5 | 49.8 | 5.2 | 1100 |
| 1 h | 35.8 | 45.3 | 55.5 | 8.7 | 1100 |
| 2 h | 30.6 | 42.0 | 54.9 | 14.5 | 1100 |
| 3 h | 25.9 | 36.2 | 51.5 | 22.6 | 1020 |

### Example 4

Solid state catalyst: 8.3 g alumina 1 (dried over night at 140° C.) and 8.3 g molecular sieve 3 Å (dried over night at 140° C. in vacuo)
Temperature: 80° C. for 3 hours

TABLE 4

| | | | trisubstituted | tetrasubstituted | |
|---|---|---|---|---|---|
| Isomers | alpha olefins | | olefins C1, | olefins | Mn |
| [mol %] | A, C6, C8 | (B) | C2, B, C7 | C3, C4, C5 | [g/mol] |
| starting | 87.1 | 8.7 | 11.4 | 1.5 | 1030 |
| material | | | | | |
| 2 h | 64.9 | 27.4 | 30.4 | 30.9 | 1170 |
| 3 h | 53.1 | 33.6 | 38.4 | 39.4 | 1100 |

### Example 5

Solid state catalyst: 16.6 g alumina 2 (dried over night at 140° C.) and 16.6 g molecular sieve 3 Å (dried over night at 140° C. in vacuo)
Temperature: 95° C. for 30 hours

TABLE 5

| | | | trisubstituted | tetrasubstituted | |
|---|---|---|---|---|---|
| Isomers | alpha olefins | | olefins C1, | olefins | Mn |
| [mol %] | A, C6, C8 | (B) | C2, B, C7 | C3, C4, C5 | [g/mol] |
| starting | 87.1 | 8.7 | 11.4 | 1.5 | 1030 |
| material | | | | | |
| 5 h | 55.5 | 36 | 42.1 | 2.4 | 1190 |
| 24 h | 37.9 | 49.5 | 58.1 | 4 | 1200 |
| 30 h | 37.1 | 49.8 | 58.3 | 4.6 | 1060 |

### Example 6

Solid state catalyst: 24.8 g Alumina3 (dried over night at 140° C.) and 24.8 g molecular sieve 5 Å (dried over night at 140° C. in vacuo)

30 g polyisobutene starting material were mixed with 30 g water-saturated n-heptane and stirred at 80° C. over 6 hours

| | | | trisubstituted | tetrasubstituted | |
|---|---|---|---|---|---|
| Isomers | alpha olefins | | olefins C1, | olefins | Mn |
| [mol %] | A, C6, C8 | (B) | C2, B, C7 | C3, C4, C5 | [g/mol] |
| starting | 87.1 | 8.7 | 11.4 | 1.5 | 1030 |
| material | | | | | |
| 1 h | 34 | 43.9 | 56 | 10 | 1130 |
| 3 h | 29 | 38.8 | 53.5 | 17.5 | 1090 |
| 6 h | 26.2 | 34.8 | 50.8 | 22.9 | 1020 |

1. A polyisobutene-containing composition, comprising:
20 to less than 65 mol % of a polyisobutene species (A) bearing an alpha-double bond,
more than 35 to 80 mol % of a polyisobutene species (B) bearing a vinylidene beta-double bond,
up to 20 mol % (in sum) of at least one polyisobutene isomer (C) other than (A) and (B),
selected from the group consisting of: 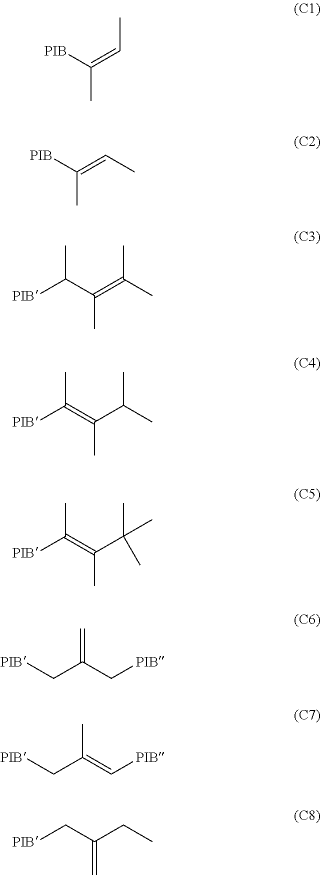
in which PIB′ and PIB″ refer to appropriately shortened polymeric backbones of the polyisobutene,
wherein at least one of the isomers selected from the group consisting of (C1), (C2), (C6), (C7), and (C8) is present,
optionally up to 4 mol % (in sum) of furthermore halogenated polyisobutenes (D1) and/or fully saturated polyisobutenes (D2),
wherein the sum of (A), (B), (C), and (D) always adds up to 100 mol %, and
the number average molecular weight Mn of the polyisobutene composition is from 500 to 10000.

2. The polyisobutene-containing according to claim 1, wherein at least one of the isomers selected from the group consisting of (C1), (C2), (C6) (C7), and (C8) independently of another is present in an amount of at least 0.5 mol %.

3. The composition according to claim 1, wherein the amount of polyisobutene isomers (C) other than (A) and (B) is from 1 to 19 mol %.

4. The composition according to claim 1, wherein the amount of halogenated polyisobutenes (D1) is not more than 2 mol %.

5. The composition according to claim 1, wherein the amount of fully saturated polyisobutenes (D2) is not more than 2 mol %.

6. A process for preparation of compositions according to claim 1, the process comprising:
choosing as a starting material a polyisobutene composition with a content of polyisobutene species (A) bearing an alpha-double bond of at least 70 mol %,
optionally at least one solvent,
optionally at least one initiator, and
treating the optionally dissolved polyisobutene composition
in the presence of at least one acidic solid state catalyst, optionally treated with at least one Brønsted-base
for a period of from 10 minutes to 36 hours
at a temperature of from 40° C. to 250° C.

7. The process according to claim 6, wherein the starting material further comprises isobutene and/or oligomers of isobutene.

8. The process according to claim 6, wherein the at least one solvent is at least one selected from the group consisting of aliphatic hydrocarbons, cycloaliphatic hydrocarbons, aromatic hydrocarbons, and halogenated hydrocarbons.

9. The process according to claim 6, wherein the at least one solvent comprises the inert components of isobutenic C₄ hydrocarbon streams.

10. The process according to claim 6, wherein the at least one acidic solid state catalyst is at least one selected from the group consisting of:
at least one natural clay mineral selected from the group consisting of: kaolinite, bentonite, attapulgite, montmorillonite, clarit, fuller's earth, zeolites (X, Y, A, H-ZSM etc), cation exchanged zeolites, and clays:
at least one acid selected from the group consisting of: H₂SO₄, H₃PO₄, and CH₂(COOH)₂ mounted on silica, quartz sand, alumina or diatomaceous earth,
cation exchange resins;
at least one metal oxide and/or sulfide selected from the group consisting of: ZnO, CdO, Al₂O₃, CeO₂, ThO₂, TiO₂, ZrO₂, SnO₂, PbO, As₂O₅, Bi₂O₃, Sb₂O₅, V₂O₅, Cr₂O₃, MoO₃, WO₃, CdS, and ZnS;
at east one metal salt selected from the group consisting of: MgSO₄, CaSO₄, SrSO₄, BaSO₄, CuSO₄, ZnSO₄, CdSO₄, Al₂(SO₄)₃, FeSO₄, Fe₂(SO₄)₃, CoSO₄, NiSO₄, Cr₂(SO₄)₃, KHSO₄, K₂SO₄, (NH₄)₂SO₄, Zn(NO₃)₂, Ca(NO₃)₂, Bi(NO₃)₃, Fe(NO₃)₃, CaCO₃, BPO₄, AlPO₄, CrPO₄, FePO₄, Cu₃(PO₄)₂, Zn₃(PO₄)₂, Mg₃(PO₄)₂, Tis(PO₄)₄, Zr₃(PO₄)₄, Ni₃(PO₄)₂, AgCl, CuCl, CaCl₂), AlCl₃, TiCl₄, SnCl₄, CaF₂, BaF₂, AgClO₄, and Mg(ClO₄)₂; and
at least one mixed oxide selected from the group consisting of: SiO₂—Al₂O₃, SiO₂—TiO₂, SiO₂—SnO₂, SiO₂—ZrO₂, SiO₂—BeO, SiO₂—MgO, SiO₂—CaO, SiO₂—SrO, SiO₂—ZnO, SiO₂—Ga₂O₃, SiO₂—Y₂O₃, SiO₂—La₂O₃, SiO₂—MoO₃, SiO₂—WO₃, SiO₂—V₂O₅, SiO₂—ThO₂, Al₂O—MgO, Al₂O₃—ZnO, Al₂O₃—CdO, Al₂O₃—B₂O₃, Al₂O₃—ThO₂, Al₂O₃—TiO₂, Al₂O₃—ZrO₂, AlO₃—V2O₅, Al₂O₃—MoO₃, Al₂O₃—WO₃, Al₂O₃—Cr₂O₃, Al₂O₃—Mn₂O₃, Al₂O₃—Fe₂O₃, Al₂O₃—Co₃O₄, Al₂O₃—NiO, TiO₂—CuO, TiO₂—MgO, TiO₂—ZnO, TiO₂—CdO, TiO₂—ZrO₂, TiO₂—SnO₂, TiO₂—Bi₂O₃, TiO₂—Sb₂O₅, TiO₂—V₂O₅, TiO₂—Cr₂O₃, TiO₂—MoO₃, TiO₂—WO, TiO₂—Mn₂O₃, TiO₂—Fe₂O₃, TiO₂—Co₃O₄, TiO₂—NiO, ZrO₂—CdO, ZnO—MgO, ZnO—Fe₂O₃, MoO₃—CoO—Al₂O₃, MoO₃—NiO—Al₂O₃, TiO₂—SiO₂—MgO, MoO₃—Al₂O₃—MgO, and heteropoly acids.

11. The process according to claim 6, wherein the at least one acidic solid state catalyst is selected from the group consisting of SiO₂, Al₂O₃, TiO₂, ZrO₂, B₂O₃, ZnO₂, Nb₂O₅, and mixtures thereof.

12. The process according to claim 6, wherein the at least one acidic solid state catalyst is selected from the group consisting of
alumina,
molecular sieves with a pore size of from 1 to 6 Å,
zeolites,
silicates,
and mixtures thereof.

13. The process according to claim 6, wherein the at least one acidic solid state catalyst without treatment with a Brønsted-base exhibits a pH-value from 3 to 8 measured in the form of a 10 wt % aqueous slurry at 25° C.

14. The process according to claim 6, wherein the at least one acidic solid state catalyst is treated with at least one Brønsted-base.

15. The process according to claim 14, wherein the at least one acidic solid state catalyst treated with the at least one Brønsted-base exhibits a pH-value from 6 to 13 measured in the form of a 10 wt % aqueous slurry at 25° C.

16. A method of making a product, comprising:
reacting of the compositions according to claim 1 in an oxidation reaction to obtain further derivatives.

17. A method of making a product, comprising:
reacting of the compositions according to claim in at least one reaction selected from the group consisting of an epoxidation reaction, a hydroformylation reaction, and an ene-reaction with maleic anhydride.

18. A polyisobutene-containing composition, comprising:
25 to 50 mol % of a polyisobutene species (A) bearing an alpha-double bond, more than 35 to 80 mol % of a polyisobutene species (B) bearing a vinylidene beta-double bond,
up to 20 mol % (in sum) of at least one polyisobutene isomer (C) other than (A) and (B),
selected from the group consisting of: 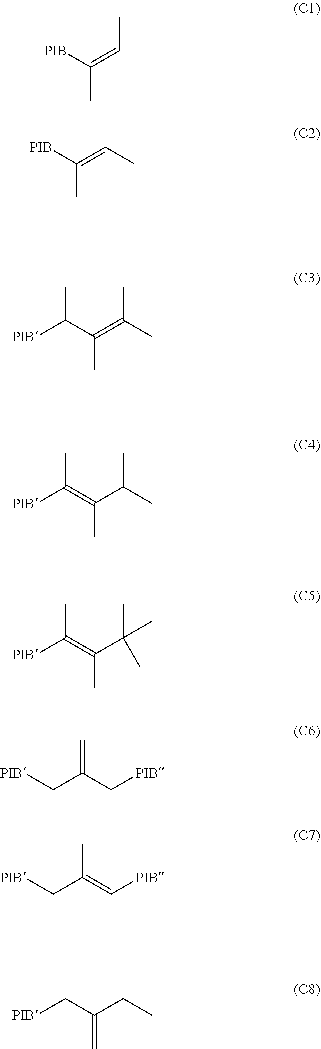
in which PIB′ and PIB″ refer to appropriately shortened polymeric backbones of the polyisobutene,
wherein at least one of the isomers selected from the group consisting of (C1), (C2), (C6), (C7), and (C8) is present,
optionally up to 4 mol % (in sum) of furthermore halogenated polyisobutenes (D1) and/or fully saturated polyisobutenes (D2),
wherein the sum of (A), (B), (C), and (D) always adds up to 100 mol %, and the number average molecular weight Mn of the polyisobutene composition is from 500 to 10000.

19. A polyisobutene-containing composition, comprising:
30 to 45 mol % of a polyisobutene species (A) bearing an alpha-double bond, more than 35 to 80 mol % of a polyisobutene species (B) bearing a vinylidene beta-double bond,
up to 20 mol % (in sum) of at least one polyisobutene isomer (C) other than (A) and (B),
selected from the group consisting of: 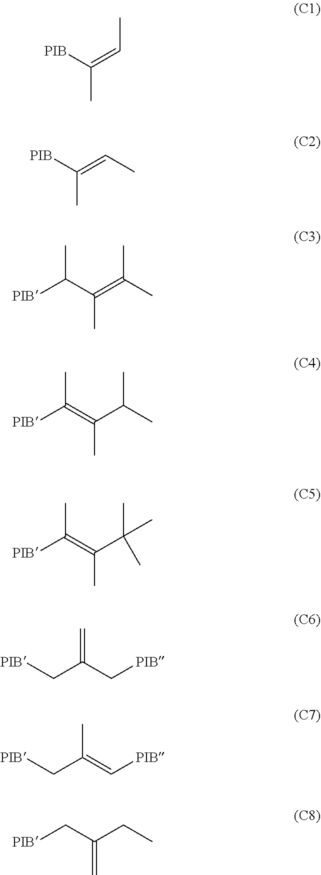
in which PIB′ and PIB″ refer to appropriately shortened polymeric backbones of the polyisobutene,
wherein at least one of the isomers selected from the group consisting of (C1), (C2), (C6), (C7), and (C8) is present,
optionally up to 4 mol % (in sum) of furthermore halogenated polyisobutenes (D1) and/or fully saturated polyisobutenes (D2),
wherein the sum of (A), (B), (C), and (D) always adds up to 100 mol %, and the number average molecular weight Mn of the polyisobutene composition is from 500 to 10000.
